(19) United States
(12) Patent Application Publication
(10) Pub. No.: US 2016/0279782 A1
(43) Pub. Date: Sep. 29, 2016

(54) Power Tool, in Particular Portable Power Tool, Having a Motorized Drive Unit and Having At Least One Sensor Device

(71) Applicant: Robert Bosch GmbH, Stuttgart (DE)

(72) Inventors: Andre Ullrich, Leinfelden-Echterdingen (DE); Andreas Schlegel, Leinfelden-Echterdingen (DE); Juergen Dietel, Stuttgart (DE); Christian Lang, Stuttgart (DE); Erwin Orendi, Esslingen (DE)

(21) Appl. No.: 15/071,974

(22) Filed: Mar. 16, 2016

(30) Foreign Application Priority Data
Mar. 23, 2015 (DE) 10 2015 205 172.2

(51) Int. Cl. B25F 5/00; B25D 16/00

(52) U.S. Cl. CPC B25F 5/00; B25D 16/00

(57) ABSTRACT

A power tool, in particular a portable power tool, has a housing, at least one motorized drive unit, and at least one sensor device. The at least one motorized drive unit is mounted in and the at least one sensor device is mounted in or on the housing. The at least one sensor device has an electronic unit and at least one sensor arranged on the electronic unit. At least one of the housing, the sensor device, and the electronic unit has at least one bearing for mounting. The bearing contains at least one resilient element configured to damp or reduce vibrations between the housing and the electronic unit.

This application claims priority under 35 U.S.C. §119 to patent application number DE 10 2015 205 172.2, filed on Mar. 23, 2015 in Germany, the disclosure of which is incorporated herein by reference in its entirety.

### BACKGROUND

The disclosure relates to a power tool, in particular a portable power tool, having a motorized drive unit and having at least one sensor device.

It is already known to integrate sensor devices having corresponding sensors for sensing different operating states into power tools, for example screwdrivers, drills, hammer drills, angle grinders, jigsaws, circular saws, lawnmowers or the like. Thus, DE 103 09 414 A1 discloses a sensor device for sensing a blockage in a portable power tool, in particular in a hammer drill, having at least one motion sensor for sensing a movement variable of the portable power tool in at least two predefined sensitivity axes.

DE 103 32 522 A1 furthermore discloses a portable power tool having a vibration-isolated handle, said portable power tool having an isolation device with passive dampers and with at least one active damping element. A regulator regulates the damping by way of sensor values sensed by a sensor, wherein the sensor is an acceleration sensor for sensing relative acceleration values of the handle of the portable power tool for active acceleration regulation.

DE 10 2012 208 180 A1 shows a handheld reciprocating jigsaw or pendulum action jigsaw having an acceleration sensor which is configured to allow detection of vibrations of the output shaft of a drive motor of the jigsaw in order to detect operating errors.

DE 10 2011 085 565 A1 discloses an autonomous work apparatus, in particular an autonomous lawnmower, having at least one computing unit and at least one collision detection device, which has at least one sensor unit, wherein the sensor unit comprises at least one acceleration sensor.

According to the prior art, the respective sensor devices or units are fastened in or on the housings of the power tools by screws, plugs, clamps or adhesive bonding, in order as a result to establish firm and intimate contact and to achieve determination of the vibratory and acceleration values that is as exact as possible.

However, it has been shown that, as a result of the vibrations of the power tools in operation, relative movements can occur at the bearings of the sensor devices or of the electronic units contained therein, for example between the housing and electronic unit. These relative movements can result for example in misdetection of blockages when the vibrations at the electronic units differ from those of the power tool as a result of play in the bearings. Moreover, wear and abrasion occur as a result of the relative movements, with the result that the play in the bearings is additionally increased and thus the risk of false tripping is further increased. As a result of this increased play, as the service life of the power tool increases, new, undesired contact points can arise between the sensor device or the electronic unit contained therein and the housing of the power tool, and these can result in false tripping.

Therefore, it is the object of the disclosure to reduce or entirely avoid the above-described disadvantages of the prior art.

### SUMMARY

The disclosure relates to a power tool, in particular a portable power tool, having a housing, having at least one motorized drive unit and having at least one sensor device, wherein the at least one motorized drive unit is mounted in and the at least one sensor device is mounted in or on the housing, and wherein the at least one sensor device has an electronic unit and at least one sensor arranged on the electronic unit. According to the disclosure, provision is made for the housing and/or the sensor device and/or the electronic unit to have at least one bearing for mounting, said bearing containing at least one resilient element for damping or reducing vibrations between the housing and the electronic unit. Advantageously, misdetection of particular, in particular safety-related operating conditions, for example an uncontrollable blockage of a hammer drill or a collision of an autonomous lawnmower, can be reduced considerably or entirely avoided to some extent. In connection with the sensor device of a semiautonomous jigsaw, it is furthermore possible to improve the detection of parameters which are necessary for semiautonomous guidance. In addition, the wear to the bearings over the service life of the power tool can be reduced and the play in the bearings minimized.

In an advantageous configuration, the sensor device senses a blockage by means of a control and regulation unit that is arranged in the housing or on the electronic unit and has corresponding evaluation electronics, and influences the motorized drive unit. In particular in connection with rotating tools, as are used in hand-held electric tools such as drills, hammer drills, angle grinders, polishing appliances or the like, this is of considerable importance in order to comply with safety-related provisions and standards. In this case, the at least one sensor can be an acceleration sensor, yaw rate sensor and/or gyro sensor. However, other sensors, known from the prior art, for vibration and motion detection are also conceivable.

A particularly simple and cost-effective possibility for vibration damping or reduction results in that the at least one resilient element is held on at least one protrusion of the bearing. In this way, the bearings already used in or on the housing of the power tool and/or on the sensor device and/or on the electronic unit can optionally be used without further modifications, as long as there is sufficient space for the resilient element. In this case, the at least one resilient element engages around the at least one protrusion and/or has a cutout into which the at least one protrusion projects.

In a particularly advantageous manner, the at least one resilient element is configured as an O-ring or a heat-shrink tube. However, depending on the requirements placed on vibration damping or reduction and the local conditions, use can also be made of a spring, a thermoplastic polymer injected into the bearing or a non-shape-related resilient element, for example a putty, wax paste or silicone paste or the like. Shape-related resilient elements, such as rubber buffers or other corresponding elastomers in a wide variety of forms, for example in the form of a cuboid, cube, ellipsoid, sphere, dumbbell, pyramid, tetrahedron, octahedron, cuboctahedron, or the like, are also conceivable.

The sensor device can be used in or on a wide variety of power tools, but preferably in or on portable power tools or power tools that operate in a substantially autonomous manner, in which vibrations or oscillations of the power tool occur on account of a motorized drive which is configured for example as an electric motor, in particular as an AC, DC or EC motor, as a piezo drive or as a combustion engine. Hybrid forms of drive are likewise conceivable.

Further advantages of the disclosure can be gathered from the features specified in the drawing and the following description.

### BRIEF DESCRIPTION OF THE DRAWINGS

The disclosure is explained by way of example in the following text with reference to FIGS. 1 to 5, wherein identical reference signs in the figures indicate identical components with an identical function.

In the figures

FIG. 1 shows a side view of a portable power tool in the form of a hammer drill with a sensor device,

FIG. 2 shows a plan view of a first exemplary embodiment of the resilient mounting, according to the disclosure, of the sensor device,

FIG. 3 shows a perspective view of the first exemplary embodiment of the mounting, according to the disclosure, of the sensor device,

FIG. 4 shows a plan view of a second exemplary embodiment of the mounting, according to the disclosure, of the sensor device, and

FIG. 5 shows a plan view of a third exemplary embodiment of the mounting, according to the disclosure, of the sensor device.

### DETAILED DESCRIPTION

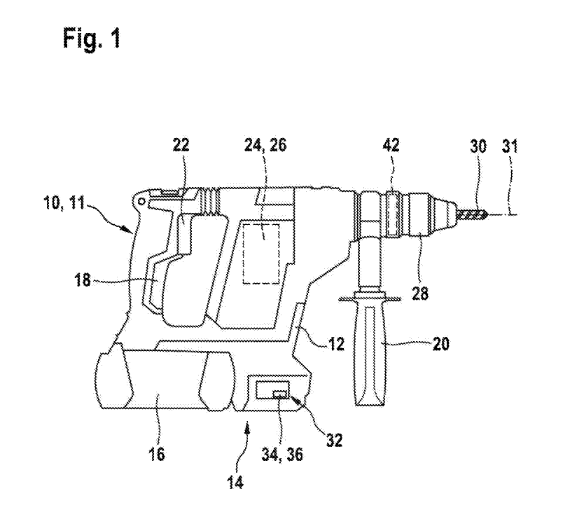

FIG. 1 shows a power tool 10, configured as a hammer drill 11, having a housing 12 and a sensor device 14. The power tool 10 additionally has a rechargeable battery 16, a main handle 18, an auxiliary handle 20 and a main operating element 22 integrated in the main handle 18. Moreover, a drive unit 24 (illustrated only schematically) in the form of a DC or EC motor 26 is provided in the power tool 10, said drive unit 24 being actuated mechanically by means of the main operating element 22 and driving an impact mechanism (not shown in more detail) and a drill chuck 28 via a transmission unit (not shown in more detail). The drill chuck 28 is provided to receive an application tool 30. Since the drive principle of a hammer drill is already well known from the prior art, it will not be dealt with further here. This is also not of further importance for the disclosure.

The sensor device 14 serves to detect an uncontrolled blockage of the hammer drill 11. The uncontrolled blockage can occur for example when the application tool 30 jams in a workpiece (not illustrated in more detail) to be machined. A reaction torque that acts on the housing 12 can in this case exceed a holding force by a user. As a result, the housing 12 rotates in an uncontrolled manner about a rotation axis 31 of the application tool 30. In this case, there is an increased risk of injury to the user.

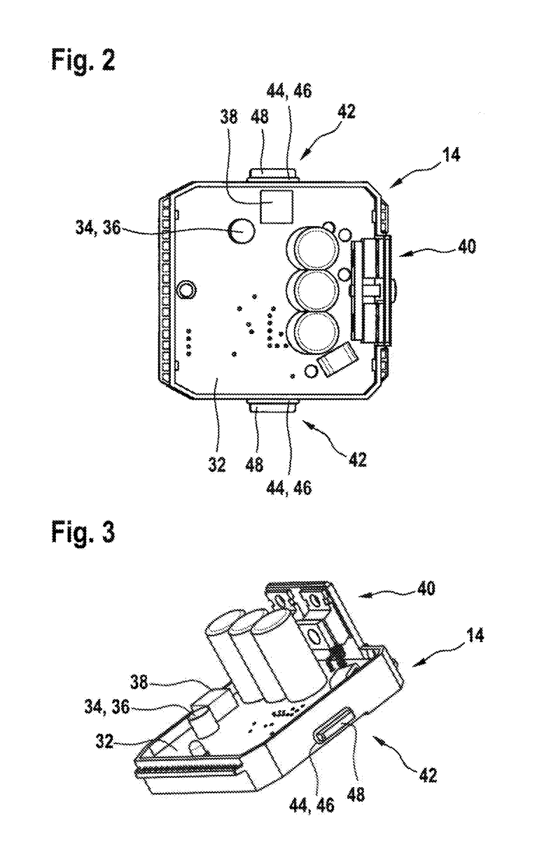

The sensor device 14, illustrated in more detail in a first exemplary embodiment in FIGS. 2 and 3, has an electronic unit 32 having at least one sensor 34, which is configured as an acceleration sensor 36 and is provided to sense at least one movement characteristic of the hammer drill 11. In the exemplary embodiment shown, the sensor device 14 is arranged in the region of the rechargeable battery 16. However, other locations within or on the power tool 10 that are suitable for sensing the movement characteristic can also be expedient. In the case of the hammer drill 11, the location, illustrated in FIG. 1, of the sensor device 14 is particularly advantageous since the greatest deviation about the rotation axis 31 with the greatest acceleration is located here in the case of uncontrolled blockage. If the movement characteristic reaches or exceeds a defined tripping threshold which is stored in a memory 38 of the sensor device 14, a control and regulation unit 40 of the sensor device 14 intervenes in the actuation of the motorized drive unit 24 and interrupts the current feed thereto. Moreover, it is conceivable for the control and regulation unit 40 to short-circuit and actively brake the motorized drive unit 24, to activate a mechanical brake (not illustrated) and/or open a mechanical overload clutch 42 arranged in the region of the drill chuck 28. A detailed description of the method for detecting an uncontrolled blockage of the hammer drill 11 will be dispensed with here, since this is already known from the prior art cited at the beginning and is of rather lesser importance for the disclosure.

In the exemplary embodiment shown according to FIGS. 2 and 3, the sensor 34, the memory 38 and the control and regulation unit 40 are all arranged on the electronic unit 32 of the sensor device 14. However, it is also conceivable for at least the memory 38 and/or the control and regulation unit 40 to be arranged separately from the sensor device 14 at a different location within or on the power tool 10. In this case, the communication between the sensor device 14 and control and regulation unit 40 and/or memory 38 can take place via wires or wirelessly. Wireless communication is expedient in particular when the sensor device 14 is not located within the housing 12 of the power tool 10 but is located on the housing 12 so as to be reachable from the outside and optionally replaceable.

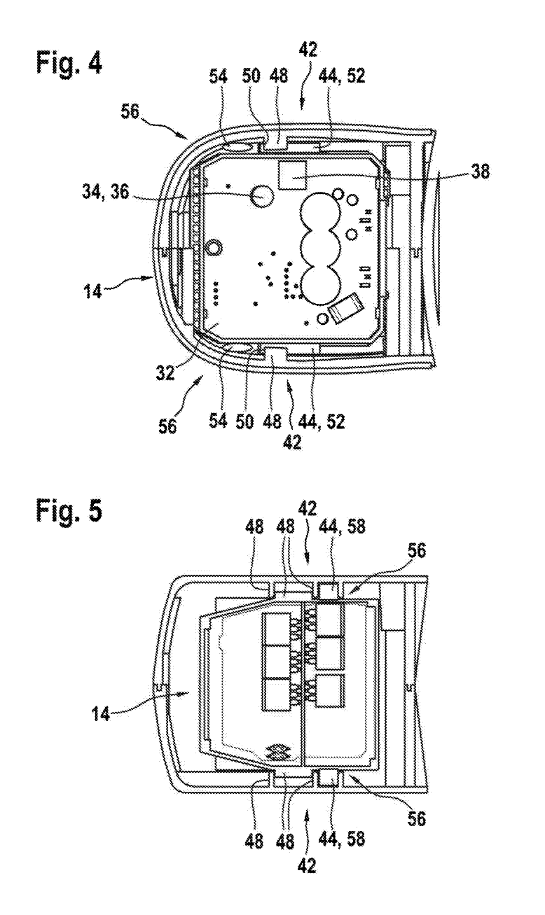

According to the prior art, the sensor device 14 is connected fixedly to the housing 12 via bearings 42. These bearings 42 are provided both on the sensor device 14 and on the housing 12 (cf. FIGS. 4 and 5). As a result of vibrations of the hammer drill 11 in operation, relative movements can occur at the bearings 42 of the sensor device 14 or the electronic unit 32 contained therein. These relative movements can result in misdetection of a blockage when the vibrations at the electronic unit 32 differ from those of the hammer drill 11 as a result of play in the bearings 42. Furthermore, wear and abrasion arise as a result of the relative movements, with the result that the play in the bearings 42 is additionally increased and thus the risk of false tripping is further increased. As a result of this increased play, as the service life of the hammer drill 11 increases, new, undesired contact points can arise between the sensor device 14 or the electronic unit 32 and the housing 12 of the hammer drill 11, and these can result in false tripping.

Therefore, according to the disclosure, provision is made for at least one bearing 42 to be provided in the housing 12 of the power tool 10 and/or on the sensor device 14 and/or on the electronic unit 32, said bearings 42 having at least one resilient element 44 for damping or reducing vibrations between the housing 12 and the electronic unit 32, in order to significantly reduce or entirely avoid misdetection of particular, in particular safety-related operating conditions. Furthermore, as a result, the wear to the bearings 42 over the service life of the power tool 10 can be reduced and the play in the bearings 42 minimized. In the exemplary embodiment according to FIGS. 2 and 3, the resilient element 44 is configured as an O-ring 46 which engages around a respective protrusion 48 on the two bearings 42 of the sensor device 14 and thus is arranged between the protrusion 48 and a corresponding receptacle (not shown in more detail) of the housing 12 of the hammer drill 11. By way of the resilient element 44, it is possible to reduce or avoid different vibrations of the housing 12 and electronic unit 32, which arise both as a result of the necessary tolerances of the sensor device 14 in all spatial directions for reception in the housing 12 and as a result of increasing play at the bearings 42 over the service life of the power tool 10.

Instead of the O-ring 46, it is also optionally possible to use a heat-shrink tube as the resilient element 44. Depending on the requirements placed on vibration reduction and the local conditions, it is also possible to use springs or the like, however.

Alternatively or in addition to engaging around the protrusion 48, the resilient element 44 can also have a cutout 50 into which the at least one protrusion 48 projects in order to be held. This is shown for example in the second exemplary embodiment according to FIG. 4. In this case, a thermoplastic polymer 52 can have been injected into the bearing 42. However, non-shape-related resilient elements, for example a putty, wax paste or silicone paste, are also possible. Mixed forms as a result of the combination of different resilient elements 44 are likewise conceivable. Moreover, it is possible also to accommodate a further resilient element 54 outside the original bearing 42, i.e. at any desired point between the sensor device 14 and the housing 12 or—not shown in FIG. 4—between the electronic unit 32 and the sensor device 14. In this way, a new bearing 56, via which coupling to the housing 12 takes place such that the vibrations between the housing 12 and electronic unit 32 are reduced or damped substantially constantly over the service life of the power tool 10, is defined. In this case, the further resilient element 54 can correspond to or differ from the resilient element 44 in or on the original bearing 42 in terms of structure and material. It is also possible, to configure the original bearing 42 without a resilient element in this case, unlike the exemplary embodiment in FIG. 4.

FIG. 5 shows a third exemplary embodiment of the disclosure, wherein the bearings 42 have each had a resilient element 44 added. The resilient element 44 is in this case configured as a simple, cuboidal rubber buffer 58 which is held 12 by protrusions 48 in the housing 12. However, other shape-related elastomers in the form of a cube, ellipsoid, tetrahedron, octahedron, cuboctahedron, sphere, dumbbell, pyramid or the like are also suitable as the resilient element 44. Combinations of different resilient elements 44, 54 within one and the same bearing 42, 56 and/or in different bearings 42, 56 are also conceivable.

Finally, it should also be noted that the exemplary embodiments shown are not limited to FIGS. 1 to 5 or to application in a hammer drill. The sensor device can be used in a wide variety of power tools, but preferably in portable power tools or power tools that operate in a substantially autonomous manner, in which vibrations or oscillations of the power tool occur on account of a motorized drive which is configured for example as an electric motor, in particular as an AC, DC or EC motor, as a piezo drive or as a combustion engine. Hybrid forms of drive are likewise conceivable. The principle of resilient clamping can furthermore be transferred to other components having sensors in an electric tool, which, on account of tolerances or for other reasons, cannot be rigidly or fixedly received, pressed in, screw-connected or adhesively bonded.

What is claimed is:

1. A power tool, comprising:
a housing;
at least one motorized drive unit; and
at least one sensor device, wherein:
the at least one motorized drive unit is mounted in the housing,
the at least one sensor device is mounted in or on the housing,
the at least one sensor device has an electronic unit and at least one sensor arranged on the electronic unit,
at least one of the housing, the sensor device, and the electronic unit has at least one bearing for mounting, and
the at least one bearing contains at least one resilient element configured to damp or reduce vibrations between the housing and the electronic unit.

2. The power tool according to claim 1, wherein:
the at least one sensor device is configured to sense a blockage via control and regulation electronics and is configured to influence the at least one motorized drive unit, and
the control and regulation electronics are arranged in the housing of the power tool or on the electronic unit.

3. The power tool according to claim 1, wherein the at least one sensor is at least one of an acceleration sensor, a yaw rate sensor and a gyro sensor.

4. The power tool according to claim 1, wherein the at least one resilient element is held on at least one protrusion of the at least one bearing.

5. The power tool according to claim 4, wherein the at least one resilient element is configured to engage around the at least one protrusion.

6. The power tool according to claim 1, wherein the at least one resilient element is configured as one of an O-ring, a heat-shrink tube, a spring, a thermoplastic polymer injected into the at least one bearing, a non-shape-related resilient element, and a shape-related resilient element.

7. The power tool according to claim 1, wherein the motorized drive is configured as an electric motor.

8. The power tool according to claim 1, wherein the power tool is a portable power tool.

9. The power tool according to claim 4, wherein the at least one resilient element has at least one cutout into which the at least one protrusion projects.

10. The power tool according to claim 5, wherein the at least one resilient element has at least one cutout into which the at least one protrusion projects.

11. The power tool according to claim 6, wherein the at least one resilient element is configured as one of a putty, a wax paste, and a silicone paste.

12. The power tool according to claim 6, wherein the at least one resilient element is configured as a rubber buffer in the form of one of a cuboid, a cube, an ellipsoid, a tetrahedron, an octahedron, a cuboctahedron, a sphere, a dumbbell, and a pyramid.

13. The power tool according to claim 7, wherein the motorized drive is configured as an AC, DC or EC motor, as a piezo drive and/or as a combustion engine.
